(19) United States
(12) Patent Application Publication
(10) Pub. No.: US 2004/0004393 A1
(43) Pub. Date: Jan. 8, 2004

(54) Brake booster

(76) Inventor: Philippe Richard, Chelles (FR)

Correspondence Address: Leo H. McCormick Jr., 2112 Mishawaka Avenue, P.O. 4721, South Bend, IN, 46634, US

(21) Appl. No.: 10/611,150

(22) Filed: Jul. 1, 2003

(30) Foreign Application Priority Data
Jul. 4, 2002 (FR) 02/08403

(51) Int. Cl. B60T 13/18; B60T 8/44

(52) U.S. Cl. 303/114.1; 303/11

(57) ABSTRACT

In order to solve a problem with the efficiency of a brake booster device, provision is made for the latter to be produced with hydraulic feedback control (36) or even in entirely hydraulic form. In this case, a master cylinder (9) of a braking circuit is equipped with a pressure chamber (6) upstream of the braking circuit. This pressure chamber is then subjected to an injection of hydraulic fluid from a pump (17). The pump is operated (18-26) on the basis of the braking requirements (E0). It is shown that a gain in compactness and in specific power can be had.

The subject of the present invention is a brake booster device. It is intended more specifically to be fitted into a vehicle, particularly a vehicle of the sedan or utility vehicle type. The purpose of the invention is to overcome problems of space and manufacturing complexity.

In the field of the motor vehicle, brake boosting devices, particularly of the pneumatic or electrohydraulic type are known. The former, pneumatic booster devices, in practice comprise a pneumatic servo-brake, equipped with a variable-volume front chamber separated from a rear chamber, also of variable volume, by a partition formed by a sealed and flexible diaphragm and by a rigid skirt-plate. The rigid skirt drives a pneumatic piston bearing, via a pushrod, on a primary piston of a master cylinder of a hydraulic braking circuit, typically a tandem master cylinder. The front chamber on the master cylinder side is connected pneumatically to a source of fluid. The rear chamber, on the opposite side to the front chamber, is placed on the brake pedal side and is connected pneumatically, in a way controlled by a valve, to a source of driving fluid, typically air at atmospheric pressure. At rest, that is to say when a driver is not depressing the brake pedal, the front and rear chambers are connected to one another while the rear chamber is isolated from atmospheric pressure. Under braking, the front chamber is first of all isolated from the rear chamber, then air is let into the rear chamber. This admission of air has the effect of driving the partition and employing pneumatically boosted braking.

The disadvantage displayed by this type of pneumatic boosting is in the volume ratio of the boost force. The specific problem is that since the boost force is provided by air at ambient pressure, which is not very high, the booster has to be large enough for the boost force to be high. When, because of constraints on size, it is not possible to produce chambers with sufficient volumes, it is possible to conceive of providing several of these in cascade. These embodiments are, however, in all cases effected at the expense of space in the vehicle engine compartment.

Also known are electrohydraulic brake boosters. Typically, an electric motor is connected to a hydraulic pump which injects a hydraulic fluid under pressure into the braking circuits downstream of the master cylinder, when these circuits are called upon. This electric motor is controlled by measuring the pressures in the front and rear chambers of the pneumatic servo-brake. Use is therefore made of two pressure detectors, coupled pneumatically to each of the chambers in order to measure the pressure therein. These detectors supply electrical signals representing these pressures. Such a solution displays numerous disadvantages.

First of all, measuring pressures in the front and rear chambers is measuring a pneumatic phenomenon and requires the presence of a sensor which may present certain difficulties as to its installation and as regards bringing it into contact with the fluid whose pressure is to be measured. Furthermore, the transfer function of calculation circuits delivering a control signal for the electric motor, on the basis of the measurements of the pressures delivered by these two sensors, may give rise to certain instabilities leading to instabilities in the slaved electrohydraulic boosting. Furthermore, the boost pumps used have therefore to be high-pressure pumps, capable of a variable delivering and, in practice, need to be driven by powerful electric motors, typically consuming 1 kilowatt. Even in the case of a vehicle with a powerful engine, producing 100 kilowatts for example, this boosting alone represents 1% of the power supplied by the engine. This is too much.

From a technological point of view, the pumps supply a high pressure, and a diaphragm, operated on the basis of the pressure measurements, allows a hydraulic fluid to be injected under pressure into the brake circuit at high pressure. The opening and closing of these diaphragms also pose problems with noise and problems of difficulty of precise control.

The invention has sought to solve these problems of size, power consumption, and difficulty of control by using a completely novel design of brake boosting circuit. The brake boosting circuit of the invention may also, but does not have to, be coupled to a pneumatic boost circuit, or even to an electrohydraulic boost circuit. The principle of the invention involves installing a pressure chamber upstream of a master cylinder between a reservoir of hydraulic fluid and this master cylinder. The pressure chamber is subjected to a hydraulic pressure by injection of hydraulic fluid performed by a pump driven by a motor, particularly a DC motor. The pressure in this pressure chamber is then used to move the primary piston of the master cylinder. A simple relationship between the pressure in the pressure chamber, a torque exerted by the DC motor, and a current passing through this motor will also be demonstrated.

The pressure chamber situated upstream of the master cylinder operates the latter mechanically or hydraulically. The remainder of the braking circuit, downstream, may be unchanged. It can be demonstrated that by adopting this approach, on the one hand, the specific efficiency at, or the volumetric efficiency of the boost function is far greater than the efficiency obtained with boosting of the pneumatic type. On the other hand, injection is into a chamber upstream of the master cylinder, at a lower pressure.

The subject of the invention is therefore a brake booster device comprising a reservoir of hydraulic fluid, a master cylinder, a feed pipe connecting the master cylinder to the reservoir, and a control rod for exerting a force to compress the hydraulic fluid in the master cylinder, characterized in that it comprises a pressure chamber upstream of the master cylinder for a flow of hydraulic fluid from the reservoir to brakes of a vehicle, a hydraulic pump fitted in the pipe between the reservoir and the pressure chamber, and means for operating the pump on the basis of a force exerted on the control rod.

The invention will be better understood from reading the description which follows and from examining the accompanying figures. These are given solely by way of indication and do not in any way limit the invention. The figures show:

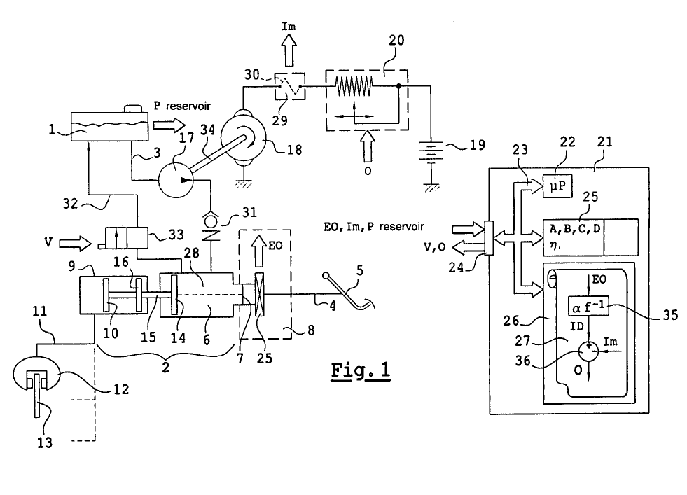

FIG. 1: a schematic depiction of the brake booster device according to the invention;

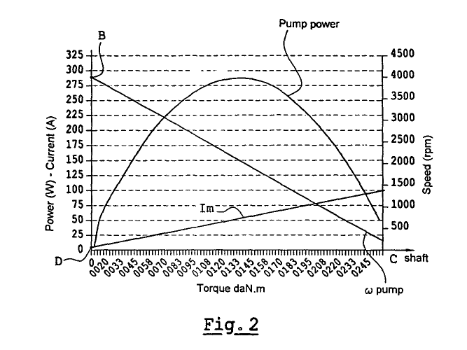

FIG. 2: diagrammatic representations of the inter-relationship between a current flowing through a DC motor, the power available with this motor, and the corresponding efficiency of the pump, as a function of the torque exerted by the shaft of the motor on the pump.

FIG. 1 shows a brake booster device according to the invention. This device comprises a reservoir 1 of hydraulic fluid, a master cylinder 2 and a feed pipe 3 for connecting the master cylinder 2 and the reservoir 1. A control rod 4, for example connected to a brake pedal 5 of a vehicle, not depicted, is used to exert a force to compress the hydraulic fluid, in this case in a pressure chamber 6 of the master cylinder. This compression force is depicted schematically here by the presence of a piston 7 driven by the rod 4 and moving in a bore produced in the chamber 6. In the prior art, the transmission of the compression force by the rod 4 is generally boosted by an inserted pneumatic booster 8, which in this instance is optional.

The invention sets out in particular to solve the problems of space, and in this case the pneumatic booster 8 will be absent. By contrast, if the invention serves solely to provide additional electrohydraulic boosting, while moreover sparing power consumption, the pneumatic booster 8 may advantageously be fitted. In practice, whether or not it is present, it can be considered that, particularly for reasons of safety, the movement of the piston 7 or at least the pressure in the master cylinder 2, will be very closely connected with the movements of the control rod 4.

Whereas in the prior art, the chamber in which the hydraulic pressure increases may be one of the chambers of the master cylinder, in the invention, the pressure chamber 6 will be an additional intermediate chamber situated upstream of the master cylinder 9 proper. For industrialization reasons, the pressure chamber 6 can be produced at the same time as, or with, the master cylinder 9 proper. However, it would be possible to provide an independent pressure chamber 6, connected hydraulically to the master cylinder 9. The master cylinder 9 may in particular be of the tandem type and comprise in addition to a primary piston, an intermediate piston 10 allowing hydraulic fluid to be injected into several independent branches such as 11 of a braking circuit. The branch 11 is also shown as terminating at a braking device 12 used to brake a disk 13 secured to a wheel (not depicted) of the vehicle.

Depicted very schematically here, the chamber 6, preferably of annular shape, comprises an annular piston 14. The piston 14 here is connected mechanically by a push rod 15 to at least one primary piston 16 of the master cylinder 9 proper. When there is no booster according to the invention, the way in which this device works may be as follows. The rod 4 moves the piston 7 which, via the chamber 6 full of hydraulic fluid, compresses the piston 14. The latter drives the piston 16 and/or the piston 10 via the pushrod 15, and this causes the brake device (12) to be applied to the disk 13.

The invention is essentially characterized by the presence of a pump 17 inserted in the feed pipe 3, between the reservoir 1 and the pressure chamber 6. The pump 17 is driven by an electric motor 18, preferably of the DC motor type. The motor 18 is, for example, powered by a power source 19, for example the vehicle battery, and its speed is controlled by a control device 20 inserted into one of the power supply leads connecting the motor 18 to the battery 19. As will be seen subsequently, current control of the motor 18 is anticipated. The current can then be adjusted, schematically speaking, using a device 20 comprising a potentiometer in series, the wiper of which is connected to one of its terminals.

The booster device of the invention also comprises means 21 for operating the pump on the basis of a force exerted on the control rod. In one example, the means 21 comprise an electronic circuit of the microprocessor type. The means 21 in this case comprise a microprocessor 22 in communication via a data, control and address bus 23, with an interface 24, a data memory 25 and a program memory 26. The means 21 may incidentally form part of an overall vehicle control device, it being possible for the overall microprocessor 22 to split its activity between various tasks, particularly that of controlling the pump 18 by running a program 27 contained in the memory 26. The interface 24 is designed to deliver commands O applied to the control circuit 20 of the pump 17.

In order to operate the pump 17 on the basis of a force exerted on the control rod 4, a sensor 25 mounted on this control rod and capable of delivering a signal, in this instance E0, measuring the force exerted by the driver's foot on the pedal 5 is preferably provided. In practice, the sensor 25 may be a pressure sensor, for example a strain gauge, of the piezoelectric effect or of some other type. Furthermore, if a pneumatic brake booster 8 is used, the sensor 25 may be a pressure sensor mounted in a reaction disk inserted between a push rod of the pneumatic booster and pressures exerted by the control rod 4 and the boost of a pneumatic piston of this booster. The reaction disk experiences compression forces associated with the force exerted by the user. The push rod of the prior art would here adopt the form of a rod 28, which is absent in this instance because it is replaced by the chamber 6.

It is also possible to dispense with the piston 7 and with the rod 4 entering the chamber 6. In this case, the rod 4 would terminate on a spring, tasked solely with providing resistance proportional to the depression of the user's foot, so that the user has a feeling of braking. This spring would, via a sensor measuring its compression, deliver a signal corresponding to the magnitude of the force exerted by the user. The signal E0 is thus measured and transmitted to the interface 24. The circuits 21 accordingly calculate, particularly by running the program 27, a command O to be applied to the circuit 20. Under these conditions, the motor 18 starts to turn, drives the pump 17 and causes the pressure in the chamber 6 to increase, bringing about braking.

In theory, it could be unnecessary for the control of the motor 18 to have feedback. This is because, given the fact that the force E0 applied by the user is measured and that there is knowledge of the state of the braking circuit at the time of this application, it would be possible to calculate a command O and to rely on the faithfulness of reproduction of the actions by the motor 18 for the expected braking effect to occur accordingly. However, in order to provide better control over braking, provision is made for a sensor 29 to be used to measure the action of the pump 17. As a preference, the sensor 29 will be a sensor for measuring a current Im passing through the motor 18. This can be achieved simply, and is shown here schematically, by the insertion of a calibrated low known-resistance resistor 30 in the circuits supplying power to the motor 18. The differences in voltage at the two terminals of the resistor 30 form the signal Im. This signal Im is also applied to the interface 24 to be transmitted to the circuit 21.

In order to maintain the pressure in the chamber 6, even if the motor 18 stops (at the end of operation for example), provision may be made for a nonreturn valve 31 to be fitted in the pipe 3, downstream of the pump 17 and upstream of the chamber 6, to prevent the high pressure in the chamber 6 from dropping through leakage back through the pump 17. The non-return valve 31 could incidentally have been sited between the reservoir 1 and the pump 17. Depending on the technology of the pump 17 and the technology of the motor 18, it might be possible to provide a speed reducer between the motor 18 and the pump 17, such that, even if no power is applied to this motor 18, it cannot run backward and therefore forms some kind of nonreturn valve, preventing the pump 17 from running backward.

Upon release of the brakes, when the user removes his foot from the brake pedal 5, the force measurement E0 is processed by the circuit 21 to produce a command V available at the interface 24. This command V can be used to allow the pressure to decrease in the chamber 6. This may be achieved in various ways. As a preference, the reservoir 1 is connected to the chamber 6 by an auxiliary pipe 32 branched off the pipe 3. The pipe 32 also has a relief valve 33 of the electrically operated type. The valve 33 receives the command V to open and let the hydraulic fluid contained in the chamber 6 return to the reservoir 1. This return of the hydraulic fluid is also brought about by return springs (not depicted) present on the various mechanical components driven by the hydraulic circuit. As an alternative, provision could be made for the nonreturn valve 21 to be pivoted by the command V, so as to “open” it. In this case, a pump 17 allowing a significant reverse leakage would be chosen.

The preferred operation of the feedback control will now be explained here, particularly with the aid of FIG. 2. This feedback control slaves the action of the pump 17 to the force E0 exerted on the control rod 4. FIG. 2 shows three curves: Im, ωₚᵤₘₚ and Pump power. These three curves are depicted in a frame of reference comprising, on the abscissae, the values of the torque C_{shaft} exerted by a shaft 34 coming out of the motor 18 to drive the pump 17. For a DC motor 18, it can be seen, according to formula 1: ωₚᵤₘₚ=A×C_{shaft}−B, with A negative, that the speed ωₚᵤₘₚ of the pump decreases as a function of the torque exerted by the shaft 34. The speed is shown on the ordinates in revolutions per minute. By contrast, the current needed to make the motor 18 turn is proportional to this torque according to the following formula 2: Iₘₒₜₒᵣ=C×C_{shaft}+D. The current is given on the ordinates in amps. In these formulae, A, B, C, and D represent coefficients.

As far as the pump power is concerned, it can be seen that it increases when the torque increases from 0.020 DaN.m to 0.133 DaN.m, then decreases down to 0.245 DaN.m. In practice, the efficiency of the pump is given by formula 3:

ηₚᵤₘₚ=(P_{chamber}−Pᵣₑₛₑᵣᵥₒᵢᵣ)×Qₚᵤₘₚ/C_{shaft}×ωₚᵤₘₚ=(η_{volumetric}×η_{mechanical})

where Q is the pump delivery rate, where the mechanical and volumetric efficiencies η are known, and almost constant as a function of the delivery rate, and where the pressure available in the reservoir 1, if this reservoir 1 is subjected to pressure, comes in as an efficiency-correcting factor. To this end, the reservoir 1 may be fitted with a sensor, not depicted in FIG. 1, to deliver a signal Pᵣₑₛₑᵣᵥₒᵢᵣ representative of this pressure in the reservoir 1.

These considerations lead to there being available, in the chamber 6, a pressure given by formula 4:

P_{chamber}=ηₚᵤₘₚ×(C_{shaft}×ωₚᵤₘₚ/Qₚᵤₘₚ)+Pᵣₑₛₑᵣᵥₒᵢᵣ.

Knowing that the true output of the pump is given by formula 5:

Q_{pump true}=C_{apacity×}η_{volumetric}×ωₚᵤₘₚ,

or alternatively by formula 6:

Q_{pump true}=C_{apacity}×(ηₚᵤₘₚ/η_{mechanical})×ωₚᵤₘₚ,

the pressure in the chamber 6 is given by formula 7:

P_{chamber}=(ηₚᵤₘₚ×(Iₘₒₜₒᵣ−D)/C)/(C_{apacity}×η_{volumetric})+Pᵣₑₛₑᵣᵥₒᵢᵣ

Furthermore, ηₚᵤₘₚ=η_{volumetric}×η_{mechanical}

And this gives

P_{chamber}=(η_{mechanical}/C_{apacity})×(Iₘₒₜₒᵣ−D)/C+Pᵣₑₛₑᵣᵥₒᵢᵣ

This explanation makes it possible to assert that the pressure in the chamber 6 is, according to formula 8: P_{chamber}=f(Iₘₒₜₒᵣ), directly proportional to the current Im. This can also be expressed as in formula 9: Iₘₒₜₒᵣ=f¹(P_{chamber}) by saying that the current in the motor 18 is a one-to-one reciprocal linear function (and therefore with no possible oscillation on the feedback control) of the pressure in the chamber. In consequence, see FIG. 1, the program 27 will contain a function 35 of the αf⁻¹ type to convert the force E0 (itself representing the pressure in the chamber 6, into a current I0 supposed to pass through the motor 18 to actuate the pump 17. This current I0 needs to be compared in a comparison step 36 with the current Im delivered by the sensor 29. The error signal is applied by way of a command O to the motor 18. The transfer function of this motor loaded by the pump produces the measured current Im.

The choice of a DC motor in which the available torque is proportional to the current, is therefore a preferred solution because the transfer function is simple. Furthermore, a DC motor, also known as a torque motor, has the advantage of very well tolerating locking. For example, the pump may therefore be of the suction and delivery type (with no reverse leakage). It may nonetheless also be of the peristaltic, diaphragm or vane type, or generally of some positive-displacement type. The last three types do not lead to stoppage of the motor when the pressure in the chamber 6 reaches the desired value.

In the particular case where the piston 7 is not present (the user merely produces a datum value E0), all the braking force is provided by the pump 17. In this case, a relatively low service pressure is chosen, on the one hand, and a sufficiently sized chamber 6 is chosen, on the other. This chamber, if annular, has a diameter particularly greater than the diameters of the chambers of the master cylinder 9, while at the same time remaining of a size far smaller than the diameter of a pneumatic booster. If the chamber 6 is not annular, it is contrived for the surface area for bearing on the piston 14 to be greater than the surface areas of the pistons 10 or 16. With these choices, it is possible using the piston 14 to actuate the pistons 16 and 10 of the master cylinder 9 efficiently.

It is also possible to measure not only the force E0, but also the time gradient of this force E0. It is then possible even to harden the feedback action by modifying the function f⁻¹. It would thus be possible in particular to take account of sharp braking.

1- A brake booster device comprising a reservoir (1) of hydraulic fluid, a master cylinder (9), a feed pipe (3) connecting the master cylinder to the reservoir, and a control rod (4) for exerting a force (E0) to compress the hydraulic fluid in the master cylinder, characterized in that it comprises a pressure chamber (6) upstream of the master cylinder for a flow of hydraulic fluid from the reservoir to (11) brakes (12) of a vehicle, a hydraulic pump (17) fitted in the pipe between the reservoir and the pressure chamber, and means (18-27) for operating the pump on the basis of a force exerted on the control rod.

2- The device according to claim 1, characterized in that the means for controlling the pressure of the pump comprise a sensor (25) for measuring the force exerted on the control rod, a sensor (30) for measuring the action of the pump, and feedback control (36) to slave the action of the pump to the force exerted on the control rod.

3- The device according to claim 2, characterized in that the pump is driven by a DC motor (18) and in that the sensor for measuring the action of the pump is a sensor for measuring the current (Im) in this DC motor.

4- The device according to claim 1, characterized in that the feed pipe comprises a nonreturn valve (31).

5- The device according to claim 4, characterized in that the nonreturn valve is situated between the pump and the pressure chamber.

6- The device according to claim 1, characterized in that it comprises a relief valve (33) placed in an auxiliary branched-off pipe (32) running from the reservoir to the pressure chamber of the master cylinder.

7- The device according to claim 1, characterized in that the master cylinder is doubled (10, 16).

8- The device according to claim 1, characterized in that the pressure chamber has a surface area for the bearing of a piston (14) that is larger than the surface area for the bearing of a piston (10, 16) of the master cylinder.
